(19) United States
(12) Patent Application Publication
(10) Pub. No.: US 2025/0346102 A1
(43) Pub. Date: Nov. 13, 2025

(54) MOUNTING STRUCTURE FOR WIND DEFLECTOR OF SUNROOF OF VEHICLE, WIND DEFLECTOR AND SUNROOF

(71) Applicant: Webasto SE, Stockdorf (DE)

(72) Inventors: Liu BAOJIA, Shanghai (CN); Yin JUN, Shanghai (CN)

(21) Appl. No.: 18/864,769

(22) PCT Filed: May 24, 2023
(86) PCT No.: PCT/EP2023/063955

§ 371 Date: Nov. 11, 2024

(30) Foreign Application Priority Data
Jun. 7, 2022 (CN) 202210637145.7

(51) Int. Cl. B60J 7/22

(52) U.S. Cl. CPC B60J 7/22

(57) ABSTRACT

Disclosed are mounting structures for a wind deflector of a sunroof of a vehicle, having a first strut and a second strut disposed facing each other, and a sunroof frame having a first support seat for pivotally connected to the first strut and a second support seat for pivotally connected to the second strut, so that the wind deflector is pivotable about a pivot axis in an assembled state. The mounting structure may have a first pivot structure at an end of the first strut to allow the first strut to be pivotally connected to the first support seat. The first pivot structure is configured to be adapted to be axially assembled to the first support seat along the pivot axis. Disclosed are a corresponding: wind deflector, bearing structure for carrying the wind deflector, sunroof, vehicle and a method for assembling the wind deflector.

### CROSS-REFERENCE TO RELATED APPLICATIONS

This application is a U.S. national phase application filed under 35 U.S.C. § 371 of International Application No. PCT/EP2023/063955, filed on May 24, 2023, published under WO 2023/237340 Al on Dec. 14, 2023, designating the United States, which claims priority from Chinese Patent Application Number 202210637145, filed on Jun. 7, 2022, which are hereby incorporated herein by reference in their entirety.

### TECHNICAL FIELD

The present disclosure relates to a mounting structure for a wind deflector of a sunroof of a vehicle, a corresponding wind deflector, a corresponding bearing structure for pivotably carrying a wind deflector, a corresponding sunroof for a vehicle, a corresponding vehicle and a corresponding method for assembling a wind deflector.

### BACKGROUND ART

With the development and progress of technology and people's increasing requirements for comfort, current vehicles are usually equipped with a sunroof. The sunroof is installed on the vehicle roof, which can effectively circulate the air in the vehicle and increase the inflow of fresh air. Meanwhile, the sunroof of the vehicle can also provide a broader view and meet the needs of photography and video recording during movement.

However, when the sunroof is open, the vehicle travelling at high speed causes a large amount of high-speed airflow to pour into the vehicle cabin, resulting in an uncomfortable feeling to the occupants. For this purpose, a wind deflector is provided to block or partially limit the air pouring into the cabin when the sunroof is open.

The wind deflector is usually pivotably mounted at a front area of the sunroof. Current practice is to install the wind deflector by way of material deformation. For example, by pressing a strut of the wind deflector from above towards a corresponding support seat arranged on a frame of the sunroof, the support seat and the strut themselves are materially deformed so that the strut is pivotably locked into the support seat. The support seat usually comprises two parts spaced apart from each other, which are to be expanded therebetween by a corresponding structure on the strut during the assembly process, and in particular, the corresponding structure on the strut needs to be compressed accordingly to easily enter the support seat.

However, such material deformation may cause damage to the corresponding components, in particular to the support seat, at least reducing the service life of the associated components. In particular, the support seat is usually formed by injection molding, in which welding marks are generated in its bottom area, and the material deformation, especially expansion of the support seat will make the support seat extremely vulnerable to damage in this area. If attempts are made to strengthen these components, deformation will in turn not easily occur, which has an adverse effect on the assembly process.

Therefore, there is an urgent need for improvement.

### SUMMARY OF THE INVENTION

For this reason, an object of the present disclosure is to provide an improved mounting structure for a wind deflector of a sunroof of a vehicle, a corresponding wind deflector, a corresponding bearing structure for pivotably carrying a wind deflector, a corresponding sunroof, a corresponding vehicle and a corresponding method for assembling a wind deflector, in order to overcome the disadvantages mentioned in the background art section and other possible disadvantages.

According to a first aspect of the disclosure, a mounting structure for a wind deflector of a sunroof of a vehicle is provided, wherein the wind deflector comprises a first strut and a second strut disposed facing each other, and a frame of the sunroof is provided with a first support seat for being pivotally connected to the first strut and a second support seat for being pivotally connected to the second strut, so that the wind deflector is pivotable about a pivot axis in an assembled state, wherein the mounting structure comprises: a first pivot structure disposed at an end of the first strut so as to allow the first strut to be pivotally connected to the first support seat, wherein the first pivot structure is configured to be axially assembled to the first support seat along the pivot axis.

According to an alternative embodiment of the disclosure, the mounting structure further comprises a second pivot structure disposed at an end of the second strut so as to allow the second strut to be pivotally connected to the second support seat, wherein the second pivot structure is configured in the same way as the first pivot structure.

According to an alternative embodiment of the disclosure, the first pivot structure is configured to be assembled to the first support seat in a form-fit manner without causing material deformation of the first support seat and/or the first pivot structure during assembling.

According to an alternative embodiment of the disclosure, the first pivot structure comprises a pivot shaft for axial insertion into a pivot hole formed in the first support seat.

According to an alternative embodiment of the disclosure, the pivot shaft extends axially outwards in the assembled state.

According to an alternative embodiment of the disclosure, the pivot hole is formed as a through-hole.

According to an alternative embodiment of the disclosure, the first strut is further provided with an axial limit structure capable of limiting an axial movement of the first strut in a direction opposite to an axial assembling direction of the first pivot structure within a predetermined pivot angle range.

According to an alternative embodiment of the disclosure, the end of the first strut is provided with a first arm and a second arm axially spaced from the first arm, and the first support seat is at least partially axially limited between the first arm and the second arm at least within the predetermined pivot angle range.

According to an alternative embodiment of the disclosure, the first arm is configured asymmetrically with the second arm.

According to an alternative embodiment of the disclosure, the first pivot structure is disposed on the first arm.

According to an alternative embodiment of the disclosure, a side of the first arm facing the second arm is provided with a first protruding step, on which the first pivot structure is disposed.

According to an alternative embodiment of the disclosure, a side of the second arm facing the first arm is provided with a second protruding step.

According to an alternative embodiment of the disclosure, the second arm is configured in such a way that the second arm can pass over the first support seat during assembling of the first strut.

According to a second aspect of the disclosure, a wind deflector for a sunroof of a vehicle is provided, wherein the wind deflector comprises the mounting structure and a connecting member connected between the first strut and the second strut.

According to a third aspect of the disclosure, a bearing structure for pivotably carrying the wind deflector is provided, wherein the bearing structure comprises the first support seat for being pivotally connected to the first strut by the mounting structure

According to an alternative embodiment of the disclosure, the first support seat is configured as a single-plate structure.

According to an alternative embodiment of the disclosure, the first support seat is configured as an injection-molded part.

According to a fourth aspect of the disclosure, a sunroof for a vehicle is provided, wherein the sunroof comprises the mounting structure or the wind deflector or the bearing structure.

According to a fifth aspect of the disclosure, a vehicle is provided, wherein the vehicle comprises the sunroof.

According to a sixth aspect of the disclosure, a method for assembling the wind deflector is provided, the method at least comprising: mounting the first pivot structure along the pivot axis to the first support seat.

According to some embodiments of the disclosure, the structure is simple, thereby simplifying the installation process, and in particular there is no obvious material deformation or even any material deformation during the installation process, which is very advantageous.

### BRIEF DESCRIPTION OF THE DRAWINGS

The principles, characteristics and advantages of the present disclosure can be better understood by describing the disclosure in more detail with reference to the accompanying drawings, in which:

FIG. 1 shows a perspective view of a partial area of a wind deflector of a sunroof of a vehicle according to an exemplary embodiment of the disclosure at a certain moment during assembling.

FIG. 2 shows an enlarged perspective view of a mounting structure at a first strut of a wind deflector to better present the mounting structure.

FIG. 3 shows a perspective view of an area of a first support seat for receiving a first strut of the wind deflector.

FIG. 4 shows a perspective view of the mounting structure just being axially assembled to the first support.

FIG. 5 shows a partial perspective view when the mounting structure is pivoted around a pivot axis into a retracted state after being assembled to the first support seat.

FIG. 6 is a partial perspective view observed from an opposite direction to FIG. 5.

### DETAILED DESCRIPTION OF EMBODIMENTS

For a clearer understanding of the technical problem to be solved, technical solutions and advantageous technical effects of the present disclosure, the disclosure will be further elaborated in conjunction with the drawings and a number of exemplary embodiments. It may be understood that the specific embodiments described here are only for the purpose of explaining the basic principles of the disclosure and cannot be simply construed as limitations on the scope of the disclosure.

First of all, it should be pointed out that the present disclosure relates to the improvement in a sunroof, in particular a wind deflector, of a vehicle and in the related aspects. However, for the sake of clarity, and also because the basic configuration of wind deflectors is known to those skilled in the art, the following description mainly focuses on the aspects involved in the improvement of the disclosure.

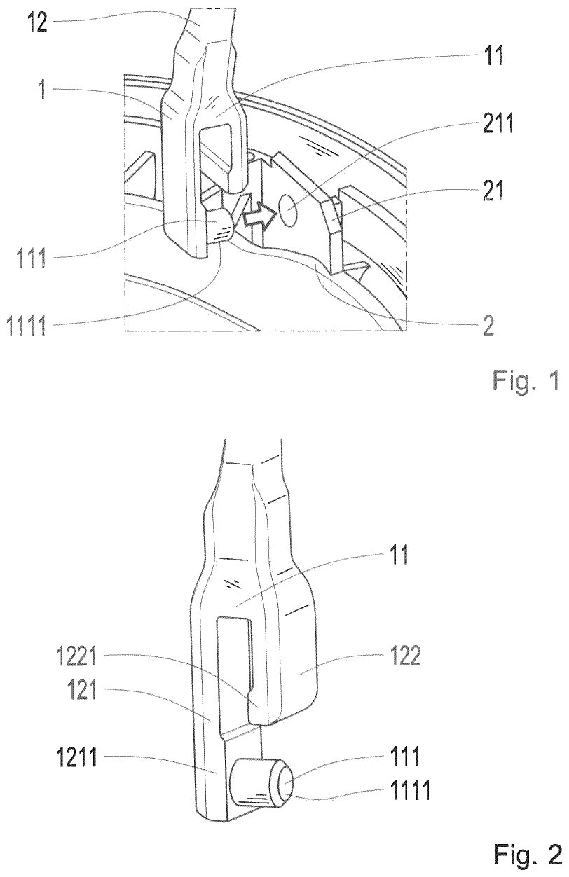

FIG. 1 shows a perspective view of a partial area of a wind deflector of a sunroof of a vehicle according to an exemplary embodiment of the disclosure at a certain moment during assembling.

A first aspect of the disclosure relates to a mounting structure for a wind deflector of a sunroof of a vehicle, which mounting structure is used for mounting the wind deflector to the sunroof, in particular to a frame of the sunroof. FIG. 1 shows a mounting structure 11 according to an exemplary embodiment of the disclosure.

As shown in FIG. 1, only part of the structure of the wind deflector 1 is shown. The wind deflector 1 is generally U-shaped with a first strut 12 and a second strut (not shown) disposed facing each other, and only the first strut 12 is shown in FIG. 1. The second strut may be configured identically to the first strut 12, but of course it may also be configured differently. The mounting structure 11 may be provided as a detachable component of the wind deflector 1, and may also be integrally formed with other parts, for example, it may be directly formed on the first strut 12 as a portion of the first strut 12. The present disclosure does not impose any limitation on this.

Also as shown in FIG. 1, the frame 2 of the sunroof is provided with a first support seat 21 for being pivotally connected to the first strut 12 and also with a second support seat (not shown) for being pivotally connected to the second strut, so that the wind deflector 1 is pivotable about a pivot axis in an assembled state, and in this way, the wind deflector 1 can be retracted when the sunroof is closed, and the wind deflector 1 is allowed to be erected when the sunroof is opened. The erected state of the wind deflector 1 can guide the airflow upwards, thereby reducing wind noise and preventing the airflow from pouring into the cabin. It is to be understood that the first strut 12 and the second strut have a common axis of rotation and, for example, may be disposed on portions at two opposite sides of the frame of the sunroof, respectively. The wind deflector 1 can be held stably by using two struts.

In the following description of the disclosure, directional or positional terms may be used, which are used with respect to the conventional arrangement of a sunroof of a vehicle.

The pivot axis is usually arranged horizontally along a width direction of the vehicle or the sunroof, and the wind deflector 1 is usually located in a front area of the sunroof.

As shown in FIG. 1, the mounting structure 11 comprises a first pivot structure 111 disposed at an end of the first strut 12 so as to allow the first strut 12 to be pivotally connected to the first support seat 21, wherein the first pivot structure 111 is configured to be adapted to be axially assembled to the first support seat 21 along the pivot axis, as indicated by the arrow in FIG. 1.

In particular, as shown in FIG. 1, the first pivot structure 111 may be axially assembled to the first support seat 21 from an inner side. Of course, those skilled in the art can also understand that, in principle, the first pivot structure may also be axially assembled to the first support seat from an outer side via a corresponding structure.

Preferably, the mounting structure 11 may further comprises a second pivot structure (not shown) disposed at an end of the second strut so as to allow the second strut to be pivotally connected to the second support seat, which second pivot structure is configured in the same or similar manner, or based on the same technical idea as the first pivot structure. In the following, the description mainly focuses on the structure of the first strut 12 and its related area, but those skilled in the art can understand that the described structure is also applicable to the structure of the second strut 12 and its related area.

According to an exemplary embodiment of the disclosure, as shown in FIG. 1, the first pivot structure 111 is configured to be assembled to the first support seat 21 in a form-fit manner without causing material deformation of the first support seat 21 and/or the first pivot structure 111 resulted from assembling operations during the assembly process, and it is in particular possible to fit the first pivot structure 111 to a corresponding mating structure on the first support seat 21 through simple axial insertion. This type of assembling operation in particular will not cause any bending moment on the first support seat 21 around a base of the first support seat 21, and in particular it does not generate any force causing the first support seat 21 to turn axially outwards. Such a bending moment or force may damage the first support seat 21. In this case, there is no corresponding counter-acting force on the first pivot structure 111, so that the first pivot structure 111 or the entire first strut 12 can be protected during the assembly process.

According to an exemplary embodiment of the disclosure, as shown in FIG. 1, the first pivot structure 111 comprises or consists of a pivot shaft 1111 for axial insertion into a pivot hole 211 formed in the first support seat 21. However, those skilled in the art can understand that, in principle, it is also possible that a pivot shaft is formed on the first support seat 21 while a pivot hole is formed on the mounting structure 11.

According to an exemplary embodiment of the disclosure, as shown in FIG. 1, the pivot shaft 1111 extends axially outwards in the assembled state, that is, towards a lateral side of the vehicle.

According to an exemplary embodiment of the disclosure, as shown in FIG. 1, the pivot hole 211 is formed as a through-hole. However, those skilled in the art can understand that, in principle, the pivot hole 211 may also be configured as a blind hole. The pivot hole 211 is preferably a circular hole, which facilitates the pivoting movement.

FIG. 2 shows an enlarged perspective view of the mounting structure 11 at the first strut 12 to better present the mounting structure 11.

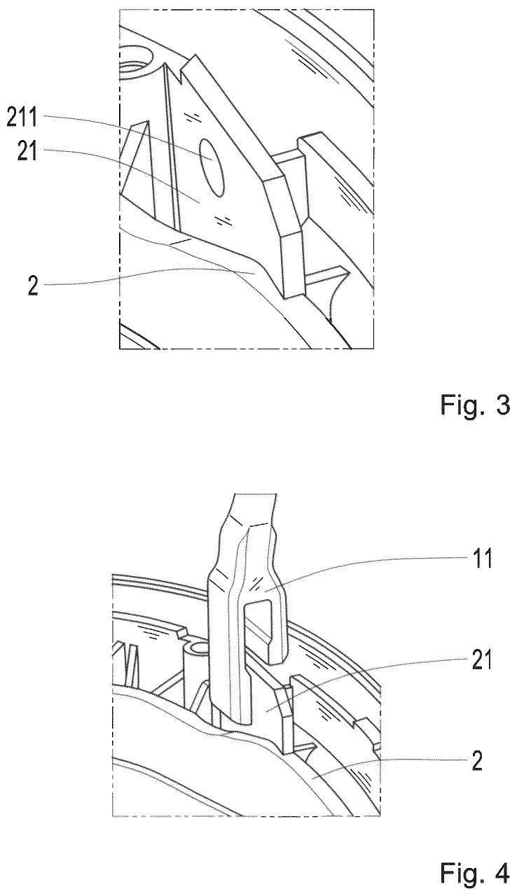

FIG. 3 shows a perspective view of an area of the first support seat 21 for receiving the first strut 12 of the wind deflector 1.

FIG. 4 shows a perspective view of the mounting structure 11 just being axially assembled to the first support seat 21.

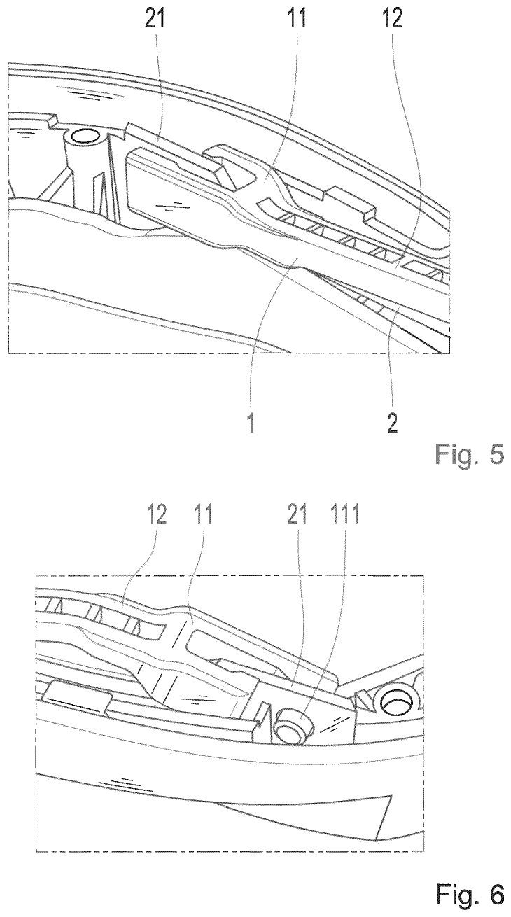

FIG. 5 shows a partial perspective view when the mounting structure 11 is pivoted around a pivot axis into a retracted state after being assembled to the first support seat 21.

FIG. 6 is a partial perspective view observed from an opposite direction to FIG. 5.

As shown in FIG. 5 and FIG. 6, the first strut 12 or the mounting structure 11 is further provided with an axial limit structure capable of limiting an axial movement of the first strut 12 or the mounting structure 11 in a direction opposite to an axial assembling direction of the first pivot structure 111 within a predetermined pivot angle range. To be specific, the first pivot structure 111 may be axially assembled to the first support seat 21 along the pivot axis in the assembling state (as shown in FIG. 1 and FIG. 4, the first strut 12 is at a certain pivot angle relative to the first support seat 21, such as in a roughly upright position), but after the assembling, when the first strut 12 rotates around the pivot axis, the first pivot structure 111 can be restricted by the axial limit structure from moving in a direction opposite to the assembling direction and thus detaching from the first support seat 21. In this way, by means of a proper design, the axial limit structure is allowed to produce a limiting effect within the predetermined pivot angle range. For example, it can always restrict the first pivot structure 111 from axially detaching from the first support seat 21 any more when pivoting towards the retracted state after being axially assembled.

Those skilled in the art can understand that the predetermined pivot angle range may be enabled by designing the axial limit structure and/or the first support seat 21 interacting with the axial limit structure.

As shown in FIG. 2, the end of the first strut 12 is provided with a first arm 121 and a second arm 122 axially spaced from the first arm 121. The first arm 121 may be arranged parallel to the second arm 122, with a slot formed therebetween for receiving the first support seat 21. It can be seen from FIG. 5 and FIG. 6 that the first support seat 21 is at least partially axially limited between the first arm 121 and the second arm 122 at least within the predetermined pivot angle range. In this case, the second arm 122 forms the axial limit structure.

According to an exemplary embodiment of the disclosure, as shown in FIG. 2, the first arm 121 is configured asymmetrically with the second arm 122. For example, the second arm 122 may be configured to be shorter than the first arm 121 so that the second arm 122 can pass over the first support seat 21, in particular from above, during the assembly process of the first strut 12 or the mounting structure 11, as shown in FIG. 4. Of course, those skilled in the art can understand that the second arm 122 can pass over the first support seat 21 during the assembly process of the first strut 12 or the mounting structure 11 in other ways, for example, the first support seat 21 may be formed thereon with a corresponding notch.

According to an exemplary embodiment of the disclosure, the first pivot structure 111 is disposed on the first arm 121.

The first arm 121 and the second arm 121 may be configured substantially in the shape of a plate.

As shown in FIG. 2, a side of the first arm 121 facing the second arm 122, in particular at the end of the first arm 121, is provided with a first protruding step 1211, on which the first pivot structure 111 is disposed.

Similarly, a side of the second arm 122 facing the first arm 121 is provided with a second protruding step 1221. Those skilled in the art can understand that the provision of the second protruding step 1221 allows a relatively stable guidance of the first strut 12 in the course of rotation.

A second aspect of the disclosure further relates to a wind deflector 1 for a sunroof of a vehicle, wherein the wind deflector 1 comprises the mounting structure 11 and a connecting member (not shown) connected between the first strut 12 and the second strut. The connecting member per se may be configured as, or be provided thereon with, a wind deflecting structure, such as a windshield strip.

A third aspect of the disclosure further relates to a bearing structure for pivotably carrying the wind deflector 1, wherein the bearing structure comprises the first support seat 21 for being pivotally connected to the first strut 12 by the mounting structure 11.

In particular, as shown in FIG. 3, the first support seat 21 may be configured as a single-plate structure. This effectively increases the strength of the first support seat 21. In particular, the first support seat 21 may be configured as an injection-molded part.

A fourth aspect of the disclosure further relates to a sunroof for a vehicle, wherein the sunroof comprises the mounting structure 11 or the wind deflector 1 or the bearing structure.

A fifth aspect of the disclosure further relates to a vehicle, which comprises the sunroof.

A sixth aspect of the disclosure further relates to a method for assembling the wind deflector 1, the method at least comprising: mounting the first strut 12 or the first pivot structure 111 along the pivot axis to the first support seat 21.

While specific embodiments of the disclosure have been described in detail here, they are for the purpose of explanation only and should not be construed as limitations on the scope of the disclosure. Various substitutions, changes and modifications can be devised without departing from the spirit and scope of the invention.

1. A mounting structure for a wind deflector of a sunroof of a vehicle, wherein the wind deflector comprises a first strut and a second strut disposed facing each other, and a frame of the sunroof is provided with a first support seat for being pivotally connected to the first strut and a second support seat for being pivotally connected to the second strut, so that the wind deflector is pivotable about a pivot axis in an assembled state, the mounting structure comprising:
a first pivot structure disposed at an end of the first strut so as to allow the first strut to be pivotally connected to the first support seat,
wherein the first pivot structure is configured to be adapted to be axially assembled to the first support seat along the pivot axis.

2. The mounting structure according to claim 1, wherein the mounting structure further comprises:
a second pivot structure disposed at an end of the second strut so as to allow the second strut to be pivotally connected to the second support seat,
wherein the second pivot structure is configured in the same way as the first pivot structure.

3. The mounting structure according to claim 1, wherein the first pivot structure is configured to be assembled to the first support seat in a form-fit manner without causing material deformation of the first support seat and/or the first pivot structure during assembling.

4. The mounting structure according to claim 1, wherein
the first pivot structure comprises a pivot shaft for axial insertion into a pivot hole formed in the first support seat.

5. The mounting structure according to claim 4, wherein the pivot shaft extends axially outwards in the assembled state; and/or the pivot hole is formed as a through-hole.

6. The mounting structure according to claim 1, wherein the first strut is further provided with an axial limit structure capable of limiting an axial movement of the first strut in a direction opposite to an axial assembling direction of the first pivot structure within a predetermined pivot angle range.

7. The mounting structure according to claim 6, wherein the end of the first strut is provided with a first arm and a second arm axially spaced from the first arm, and the first support seat is at least partially axially limited between the first arm and the second arm at least within the predetermined pivot angle range.

8. The mounting structure according to claim 7, wherein the first arm is configured asymmetrically with the second arm; and/or the first pivot structure is disposed on the first arm.

9. The mounting structure according to claim 7, wherein a side of the first arm facing the second arm is provided with a first protruding step, on which the first pivot structure is disposed; and/or a side of the second arm facing the first arm is provided with a second protruding step.

10. The mounting structure according to claim 7, wherein the second arm is configured in such a way that the second arm can pass over the first support seat during assembling of the first strut.

11. A wind deflector for a sunroof of a vehicle, wherein the wind deflector comprises the mounting structure according to claim 1, and a connecting member connected between the first strut and the second strut.

12. A bearing structure for pivotably carrying the wind deflector according to claim 11, wherein the bearing structure comprises the first support seat for being pivotally connected to the first strut by the mounting structure.

13. The bearing structure according to claim 12, wherein the first support seat is configured as a single-plate structure; and/or the first support seat is configured as an injection-molded part.

14. A sunroof for a vehicle, wherein the sunroof comprises the mounting structure according to claim 1.

15. A vehicle, wherein the vehicle comprises the sunroof according to claim 11.

16. A method for assembling the wind deflector according to claim 11, the method at least comprising: mounting the first pivot structure along the pivot axis to the first support seat.

17. A sunroof for a vehicle, wherein the sunroof comprises the wind deflector according to claim 11.

18. A sunroof for a vehicle, wherein the sunroof comprises the bearing structure according to claim 12.
